(19) United States
(12) Patent Application Publication
(10) Pub. No.: US 2024/0259751 A1
(43) Pub. Date: Aug. 1, 2024

(54) Audio Signal Processing Method, Apparatus, and Audio Signal Processing System

(71) Applicant: Yamaha Corporation, Hamamatsu-shi (JP)

(72) Inventor: Tadashi MORIKAWA, Hamamatsu-shi (JP)

(21) Appl. No.: 18/606,116

(22) Filed: Mar. 15, 2024

Related U.S. Application Data
(63) Continuation of application No. PCT/JP22/32928, filed on Sep. 1, 2022.

(30) Foreign Application Priority Data
Sep. 17, 2021 (JP) 2021-152271

(51) Int. Cl. H04S 7/00; H04S 1/00

(52) U.S. Cl. CPC H04S 7/302; H04S 1/007; H04S 2400/11

(57) ABSTRACT

An audio signal processing method includes obtaining, performing, and outputting. The step of obtaining includes obtaining localization control information that determines an acoustic image localization position of an own terminal in an audio signal processing system. The step of performing includes performing localization processing on the audio signal of the own terminal, based on the obtained localization control information. The step of outputting includes outputting the audio signal on which the localization processing has been performed.

### CROSS-REFERENCE TO RELATED APPLICATIONS

This application is a continuation of PCT Application No. PCT/JP2022/032928, filed on Sep. 1, 2022, which claims priority to Japanese Application No. 2021-152271, filed on Sep. 17, 2021. The contents of these applications are incorporated herein by reference in their entirety.

### BACKGROUND

An embodiment of the present disclosure relates to an audio signal processing system, an audio signal processing method in the audio signal processing system, and a terminal that executes the audio signal processing method.

Conventionally, a configuration in which a distribution platform such as a server that manages an online conference performs acoustic image localization has been known. For example, Japanese Unexamined Patent Application Publication No. 2013-17027 discloses a configuration in which a management device (a server for communication) that manages an online conference controls the acoustic image localization of each terminal.

However, in a case in which the structure of localization control is not present on the existing distribution platform side, localization processing disclosed in Japanese Unexamined Patent Application Publication No. 2013-17027 is not able to be implemented.

### SUMMARY

In view of the above circumstances, one aspect of the present disclosure is directed to provide an audio signal processing method that is able to implement appropriate acoustic image localization processing without depending on a distribution platform.

An audio signal processing method is used in an audio signal processing system configured by a plurality of terminals that output an audio signal. The plurality of terminals each obtain localization control information that determines an acoustic image localization position of the own terminal in the audio signal processing system, perform localization processing on the audio signal of the own terminal, based on the obtained localization control information, and output the audio signal on which the localization processing has been performed.

An embodiment of the present disclosure is able to implement appropriate acoustic image localization processing without depending on a distribution platform.

### BRIEF DESCRIPTION OF THE DRAWINGS

FIG. 1 is a block diagram showing a configuration of an audio signal processing system 1;

FIG. 2 is a block diagram showing a configuration of a terminal 11A;

FIG. 3 is a flowchart showing an operation of the terminal 11A;

FIG. 4 is a flowchart showing an operation of a management device 12;

FIG. 5 is a chart showing an example of localization control information;

FIG. 6 is a flowchart showing an operation of a terminal 11A;

FIG. 7 is a flowchart showing an operation of a terminal 11A;

FIG. 8 is a flowchart showing an operation of a management device 12;

FIG. 9 is a block diagram showing a concept of a video signal that each apparatus in the audio signal processing system 1 sends; and

FIG. 10 is a block diagram showing a concept of a localization position of a sound of each terminal in an audio signal processing system 1A.

### DETAILED DESCRIPTION

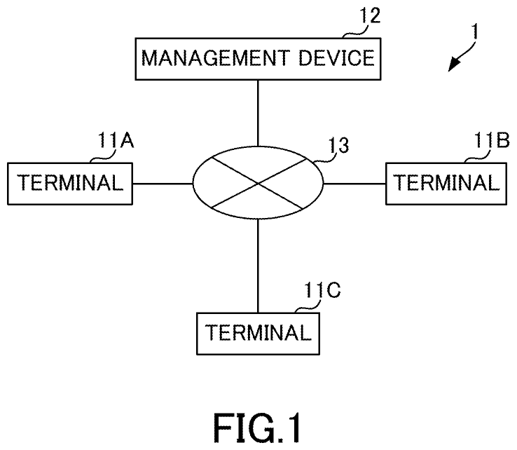

FIG. 1 is a block diagram showing a configuration of an audio signal processing system 1. The audio signal processing system 1 includes a plurality of terminals (a terminal 11A, a terminal 11B, and a terminal 11C) and a management device 12.

The terminal 11A, the terminal 11B, the terminal 11C, and the management device 12 are connected through a network 13. The network 13 includes a LAN (a local area network) or the Internet.

The terminal 11A, the terminal 11B, and the terminal 11C each are an information processing apparatus such as a personal computer.

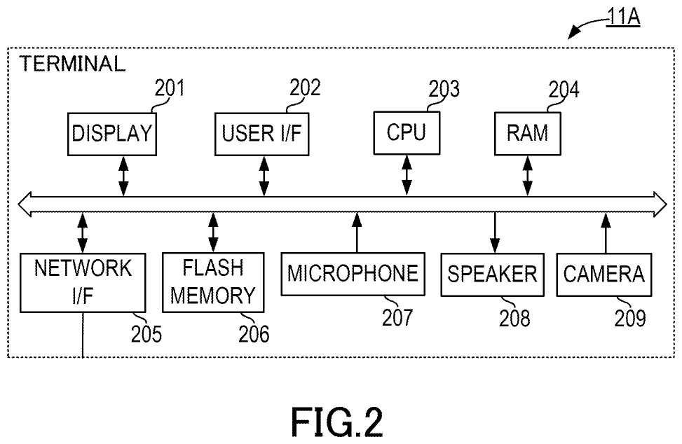

FIG. 2 is a block diagram showing a configuration of a terminal 11A. While FIG. 2 illustrates the configuration of the terminal 11A as a representative example, the terminal 11B and the terminal 11C also have the same configurations and functions.

The terminal 11A includes a display 201, a user I/F 202, a CPU 203, a RAM 204, a network I/F 205, a flash memory 206, a microphone 207, a speaker 208, and a camera 209. It is to be noted that the microphone 207, the speaker 208, and the camera 209 may be built in the terminal 11A or may be connected as an external device.

The CPU 203 is a controller that reads out a program stored in the flash memory 206 being a storage medium to the RAM 204 and implements a predetermined function. It is to be noted that the program that the CPU 203 reads out does not need to be stored in the flash memory 206 in the own apparatus. For example, the program may be stored in a storage medium of an external apparatus such as a server. In such a case, the CPU 203 may read out the program each time from the server to the RAM 204 and may execute the program.

The flash memory 206 stores an application program for an online conference. The CPU 203 reads out the application program for an online conference to the RAM 204.

The CPU 203 outputs an audio signal obtained by the microphone 207 to the management device 12 through the network I/F 205 by the function of the application program. The CPU 203 outputs an audio signal of two channels (a stereo channel). The CPU 203 outputs a video signal obtained by the camera 209 to the management device 12 through the network I/F 205.

The management device 12 receives an audio signal and a video signal from the terminal 11A, the terminal 11B, and the terminal 11C. The management device 12 mixes the audio signals received from the terminal 11A, the terminal 11B, and the terminal 11C. In addition, the management device 12 combines the video signals received from the terminal 11A, the terminal 11B, and the terminal 11C into one video signal. The management device 12 distributes the mixed audio signal and the synthesized video signal to the terminal 11A, the terminal 11B, and the terminal 11C.

The CPU 203 of each of the terminal 11A, the terminal 11B, and the terminal 11C outputs the audio signal distributed from the management device 12, to the speaker 208. The CPU 203 outputs the video signal distributed from the management device 12, to the display 201. As a result, the user of each terminal can hold an online conference.

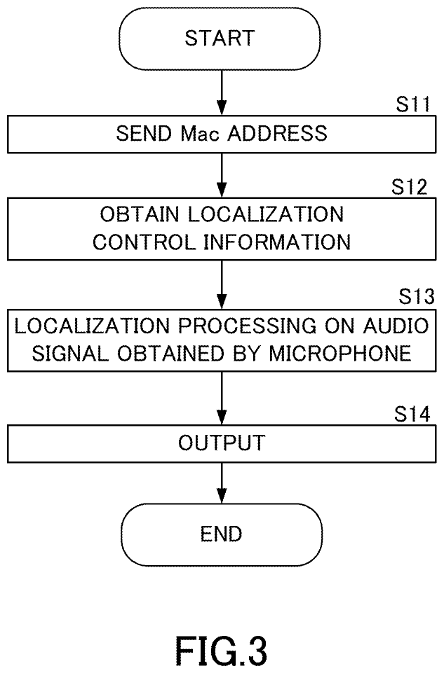

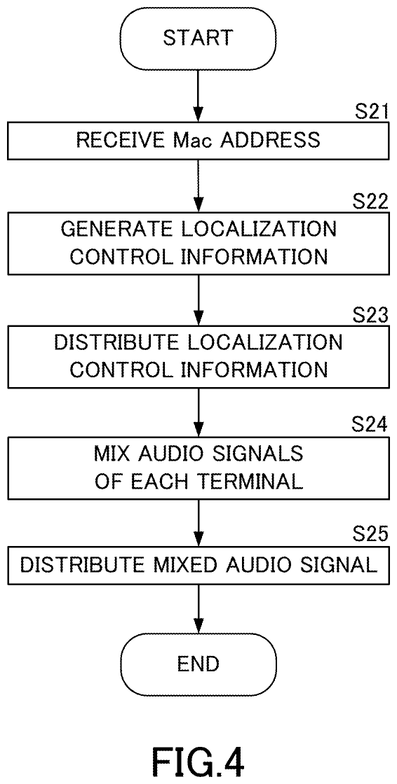

FIG. 3 is a flowchart showing an operation of the terminal 11A when an online conference starts. FIG. 4 is a flowchart showing an operation of the management device 12 when the online conference starts. The terminal 11B and the terminal 11C perform the same operations as the terminal 11A.

First, the terminal 11A sends a Mac address to the management device 12 as an example of unique identification information of the own terminal (S11). Similarly, the terminal 11B and the terminal 11C send a Mac address to the management device 12 as an example of the unique identification information of the own terminal. The management device 12 receives the Mac address from each of the terminal 11A, the terminal 11B, and the terminal 11C (S21). Then, the management device 12 generates localization control information (S22). The localization control information is information that determines an acoustic image localization position of each terminal in the audio signal processing system 1.

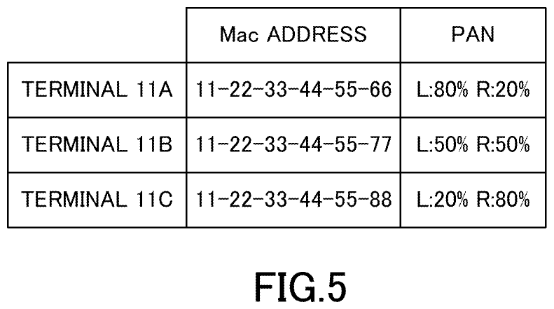

FIG. 5 is a chart showing an example of the localization control information. The localization control information associates identification information with information that shows the localization position of a terminal for each terminal. In this example, the identification information of a terminal is the Mac address. The identification information may also be a user name of each terminal, a mail address, a unique ID that the management device 12 assigns in an online conference, or the like.

In addition, in this example, the information that shows the localization position is information that shows a parameter (a volume balance of an L channel and an R channel) of panning. For example, the localization control information of the terminal 11A shows the volume balance of 80% for the L channel and 20% for the R channel. In such a case, the audio signal of the terminal 11A is localized on a left side. For example, the localization control information of the terminal 11B shows the volume balance of 50% for the L channel and 50% for the R channel. In such a case, the audio signal of the terminal 11B is localized in the center. The localization control information of the terminal 11C shows the volume balance of 20% for the L channel and 80% for the R channel. In such a case, the audio signal of the terminal 11C is localized on a right side.

The management device 12, as an example, determines the localization position, based on order of receiving the Mac addresses. In short, the management device 12 determines the localization position, based on order of connection to the online conference.

In this example, the management device 12 places the localization position of each terminal from the left side to the right side in order from the terminal that participates in the online conference. For example, the management device 12, in a case in which three terminals participate in the online conference, localizes the terminal that first participates in the online conference on the left side, localizes the terminal that next participates in the online conference in the center, and localizes the terminal that lastly participates in the online conference on the right side. The terminal 11A first connects with the management device 12 and sends the Mac address, the terminal 11B then connects with the management device 12 and sends the Mac address, and the terminal 11C lastly connects with the management device 12 and sends the Mac address. Therefore, the management device 12 localizes the terminal 11A on the left side, localizes the terminal 11B in the center, and localizes the terminal 11C on the right side.

As a matter of course, generation of such localization control information is only an example. For example, the management device 12 may localize the terminal that first participates in the online conference on the right side, may localize the terminal that next participates in the online conference in the center, and may localize the terminal that lastly participates in the online conference on the left side. In addition, the number of terminals that participate in the online conference is not limited to this example. For example, the management device 12, in a case in which two terminals participate in the online conference, may localize the terminal that first participates in the online conference on the right side and may localize the terminal that next participates in the online conference on the left side. In either case, the management device 12 localizes a plurality of terminals that participate in the online conference in respective different positions.

In addition, the localization control information may be generated based on the unique identification information of each terminal. For example, when the identification information is a Mac address, the management device 12 may determine the localization position in ascending order of the Mac address. The management device 12, in a case of FIG. 5, for example, localizes the terminal 11A with the lowest number of the Mac address on the left side, localizes the terminal 11B with the next lowest number of the Mac address in the center, and localizes the terminal 11C on the right side.

Moreover, the localization control information may be generated based on an attribute of a user of each terminal. For example, the user of each terminal has an account level in the online conference as the attribute. The localization control information is determined in ascending order of the account level. The management device 12, for example, localizes a user with a higher account level in the center and localizes a user with a lower account level at a left end or right end.

The management device 12 distributes the localization control information generated as described above, to the terminal 11A, the terminal 11B, and the terminal 11C (S23). The terminal 11A, the terminal 11B, and the terminal 11C each obtain the localization control information (S12). Then, the terminal 11A, the terminal 11B, and the terminal 11C each perform localization processing on the audio signal obtained by the microphone 207 (S13). For example, the terminal 11A performs panning processing so that the volume balance of the audio signal of the stereo channel obtained by the microphone 207 may be 80% for the L channel and 20% for the R channel. The terminal 11B performs the panning processing so that the volume balance of the audio signal of the stereo channel obtained by the microphone 207 may be 50% for the L channel and 50% for the R channel. The terminal 11C performs the panning processing so that the volume balance of the audio signal of the stereo channel obtained by the microphone 207 may be 20% for the L channel and 80% for the R channel.

The terminal 11A, the terminal 11B, and the terminal 11C each output the audio signal on which the localization processing has been performed (S14). The management device 12 receives and mixes the audio signals from the terminal 11A, the terminal 11B, and the terminal 11C (S24), and distributes the mixed audio signal to the terminal 11A, the terminal 11B, and the terminal 11C (S25).

In this manner, the audio signal processing system 1 according to the present embodiment outputs the audio signal on which each terminal that participates in an online conference has performed the localization processing. Therefore, the management device 12 being a distribution platform of the online conference does not need to perform the localization processing. As a result, the audio signal processing system 1 according to the present embodiment is able to implement appropriate acoustic image localization processing without depending on a distribution platform even when the structure of localization control is not present on the existing distribution platform side.

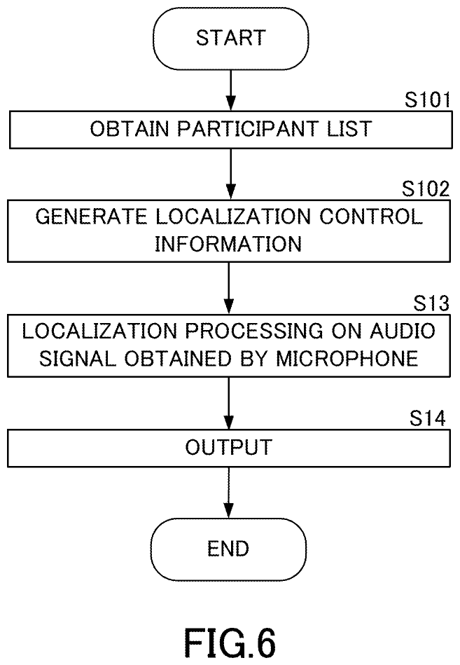

The above embodiment shows an example in which the management device 12 generates localization control information. However, the localization control information may be generated by each terminal. FIG. 6 is a flowchart showing an operation of a terminal 11A according to a first modification. The same reference numerals are used to refer to operations common to the operations shown in FIG. 3, and the description will be omitted. The terminal 11B and the terminal 11C perform the same operations as the terminal 11A.

The terminal 11A obtains a participant list from the management device 12 (S101). The participant list includes the participating time of an online conference of each terminal, and the identification information (a Mac address, a user name, a mail address, a unique ID that the management device 12 assigns in the online conference, or the like, for example) of each terminal.

The terminal 11A generates localization control information based on the obtained participant list (S102). A generation rule for the localization control information based on the participant list is the same in all the terminals of the audio signal processing system 1. For example, the generation rule associates the order of time of participation in the online conference with the localization position, one-to-one. For example, in a case in which three terminals participate in the online conference, the generation rule localizes the terminal that first participates in the online conference on the left side, localizes the terminal that next participates in the online conference in the center, and localizes the terminal that lastly participates in the online conference on the right side.

The audio signal processing system 1 according to the first modification, since generating and obtaining the localization control information at each terminal, does not need to generate the localization control information in the management device 12. The management device 12 has a participant list, may only distribute the audio signal of two channels (a stereo channel), and does not need to perform processing with respect to localization at all. Therefore, the configuration and operation of the audio signal processing system 1 according to the present embodiment are able to be implemented in any platform that has a participant list and distributes the audio signal of two channels (a stereo channel).

In the above embodiment, the information that shows the localization position is information that shows the parameter (the volume balance of an L channel and an R channel) of panning. However, the localization control information may be an HRTF (Head Related Transfer Function), for example. The HRTF expresses a transfer function from a virtual sound source position to the right ear and left ear of a user. For example, the localization control information of the terminal 11A shows such an HRTF that localizes the audio signal on the left side of the user. In such a case, the terminal 11A performs binaural processing to convolve the HRTF to be localized on the left side of the user, on the audio signal of each of the L channel and the R channel. In addition, for example, the localization control information of the terminal 11B shows such an HRTF that localizes the audio signal behind the user. In such a case, the terminal 11B performs binaural processing to convolve the HRTF to be localized behind the user, on the audio signal of each of the L channel and the R channel. In addition, for example, the localization control information of the terminal 11C shows such an HRTF that localizes the audio signal on the right side of the user. In such a case, the terminal 11C performs binaural processing to convolve the HRTF to be localized on the right side of the user, on the audio signal of each of the L channel and the R channel.

The parameter of panning is a volume balance between the left and the right, and the localization control information is one-dimensional (left and right positions) information. Therefore, in the parameter of panning, when a large number of participants are present in the online conference, the localization positions of voices of each user become closer to each other, which makes it difficult to localize the voices of each user in different positions. However, the localization control information of the HRTF is three-dimensional information. Therefore, the audio signal processing system 1 according to the second modification, even when a larger number of participants are present in the online conference, is able to localize the voices of each user in different positions.

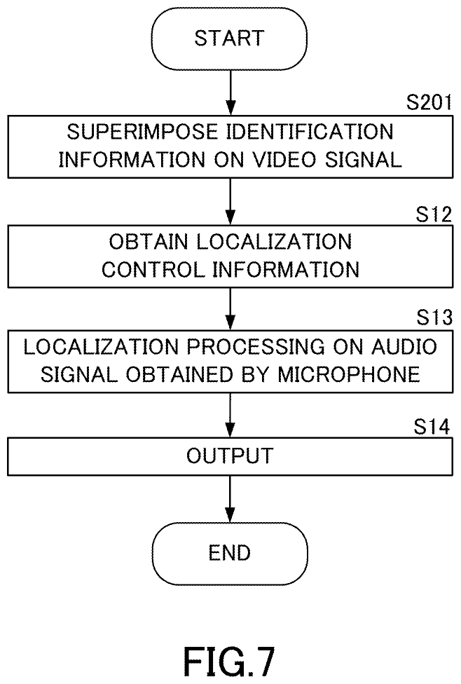

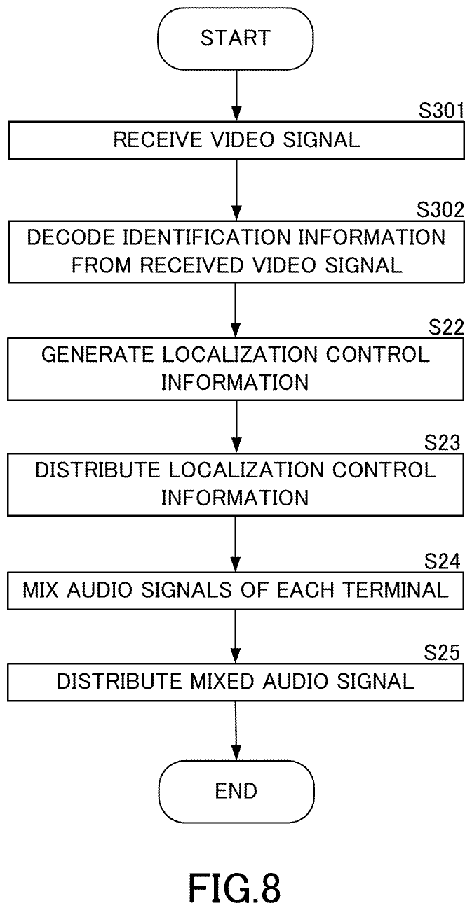

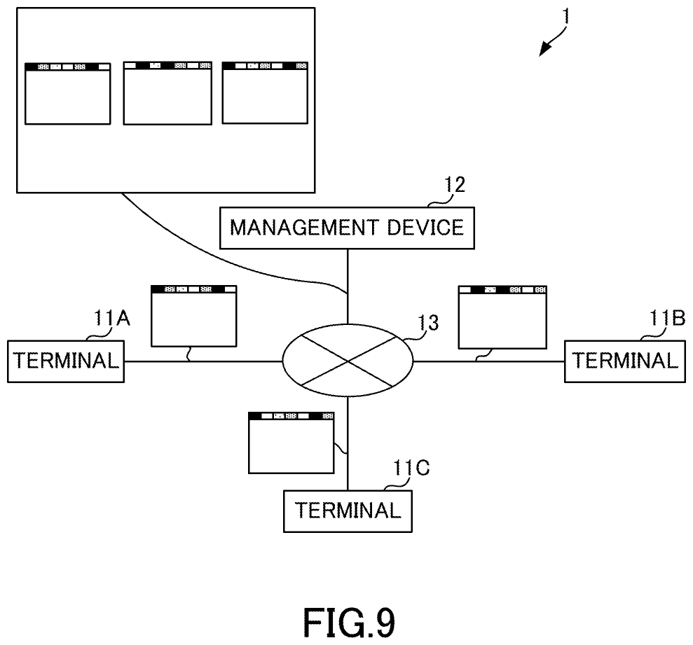

An audio signal processing system 1 according to a third modification is an example in which a management device 12 or each terminal generates localization control information based on a video signal. FIG. 7 is a flowchart showing an operation of a terminal 11A according to the third modification. The same reference numerals are used to refer to operations common to the operations shown in FIG. 3, and the description will be omitted. The terminal 11B and the terminal 11C perform the same operations as the terminal 11A. FIG. 8 is a flowchart showing an operation of a management device 12 according to the third modification. The same reference numerals are used to refer to operations common to the operations shown in FIG. 4, and the description will be omitted. FIG. 9 is a block diagram showing a concept of a video signal that each apparatus in the audio signal processing system 1 sends.

The terminal 11A, the terminal 11B, and the terminal 11C output the video signal obtained by the camera 209, to the management device 12. At this time, the terminal 11A, the terminal 11B, and the terminal 11C superimpose identification information on the video signal (S201). For example, the terminal 11A, the terminal 11B, and the terminal 11C encode some pixels of the video signal by the identification information.

The terminal 11A, the terminal 11B, and the terminal 11C code the identification information by using a plurality of pixels from the origin (0, 0) being the uppermost left pixel, among the video signals each of which is obtained by the camera 209. For example, the terminal 11A, the terminal 11B, and the terminal 11C encode an RGB value of a pixel by the identification information, using white (R, G, B=255, 255, 255) as the bit data of 1 and black (R, G, B=0, 0, 0) as the bit data of 0. When the number of pixels of the video signal is 1280×720, for example, the terminal 11A, the terminal 11B, and the terminal 11C encode the identification information by using 1280 pixels in one line (0, 0-1279, 0) being the coordinates of Y=0 of the video signal.

The management device 12 receives the video signal from the terminal 11A, the terminal 11B, and the terminal 11C (S301), and decodes the above identification information (S302). It is to be noted that the management device 12 may combine the video signals received from the terminal 11A, the terminal 11B, and the terminal 11C without changing anything or may combine the video signals after deleting the 1280 pixels in one line being the coordinates of Y=0. Alternatively, the management device 12 may combine the video signals after replacing all the 1280 pixels in one line being the coordinates of Y=0 with white (R, G, B=255, 255, 255) or black (R, G, B=0, 0, 0).

When the management device 12 combines the video signals received from the terminal 11A, the terminal 11B, and the terminal 11C without changing anything, as shown in FIG. 9, a video of each participant displayed during an online conference has pixels obtained by encoding only the uppermost one line. However, the video is obtained by encoding only the uppermost one line and does not interfere with the viewing and listening of the video in the online conference.

The audio signal processing system 1 according to the third modification is an example in which each terminal is able to send the identification information through the video signal. Therefore, the audio signal processing system 1 according to the third modification is able to obtain the identification information of each terminal, even when the platform of an online conference has no way of receiving the identification information such as a Mac address.

It is to be noted that the identification information may be decoded at each terminal. In such a case, each terminal generates localization control information based on the decoded identification information. In this case, the generation rule for the localization control information based on the identification information is the same in all the terminals of the audio signal processing system 1. In this case, the management device 12 does not need to decode the identification information, Therefore, the audio signal processing system 1 according to the third modification, since the management device 12 does not need to manage the identification information such as a Mac address, is implemented by any distribution platform that distributes the audio signal of two channels (a stereo channel).

It is to be noted that each terminal, when decoding the identification information, preferably encodes the RGB value of a plurality (4×4, for example) of pixels of the video signal to the bit data (R, G, B=255, 255, 255) of 1 or the bit data (R, G, B=0, 0, 0) of 0. Accordingly, even when the management device 12 causes the video signal of each terminal to contract to one fourth of the size, for example, and combine the video signals, the encoded pixel remains. Therefore, each terminal is able to appropriately decode the identification information.

Each terminal in an audio signal processing system 1 according to a fourth modification performs processing to add an indirect sound to an audio signal. Each terminal in the audio signal processing system 1 according to the fourth modification is able to reproduce a sound field such that a conversation may be performed in a predetermined acoustic space such as a conference room or a hall, by adding an indirect sound to an audio signal.

The indirect sound is added by convolving an impulse response measured in advance in the predetermined acoustic space in which the sound field is to be reproduced, for example, to an audio signal. The indirect sound includes an early reflected sound and a late reverberant sound. The early reflected sound is a reflected sound such that the arrival direction of the sound is clearly fixed, and the late reverberant sound is a reflected sound such that the arrival direction of the sound is not fixed. Therefore, each terminal may perform binaural processing to convolve an HRTF such that an acoustic image may be localized in a position shown by position information of each sound source of the early reflected sound, on the audio signal obtained at each terminal. In addition, the early reflected sound may be generated based on information that shows the position and level of each sound source of the early reflected sound. Each terminal performs delay processing according to the position of each sound source of the early reflected sound, on the audio signal obtained at each terminal, and controls the level of the audio signal based on level information on each sound source of the early reflected sound. As a result, each terminal is able to clearly reproduce the early reflected sound in a predetermined acoustic space.

Moreover, each terminal may reproduce the sound field of a different acoustic space. The user of each terminal specifies the acoustic space to be reproduced. Each terminal obtains space information that shows the specified acoustic space from the management device 12 or the like. The space information includes information on the impulse response. Each terminal adds an indirect sound to the audio signal by using the impulse response of the specified space information. It is to be noted that the space information may be information that shows the size of the predetermined acoustic space such as a conference room or a hall, the reflectivity of a wall surface, or the like. Each terminal lengthens the late reverberant sound as the size of the acoustic space is increased. In addition, each terminal increases the level of the early reflected sound as the reflectivity of a wall surface is increased.

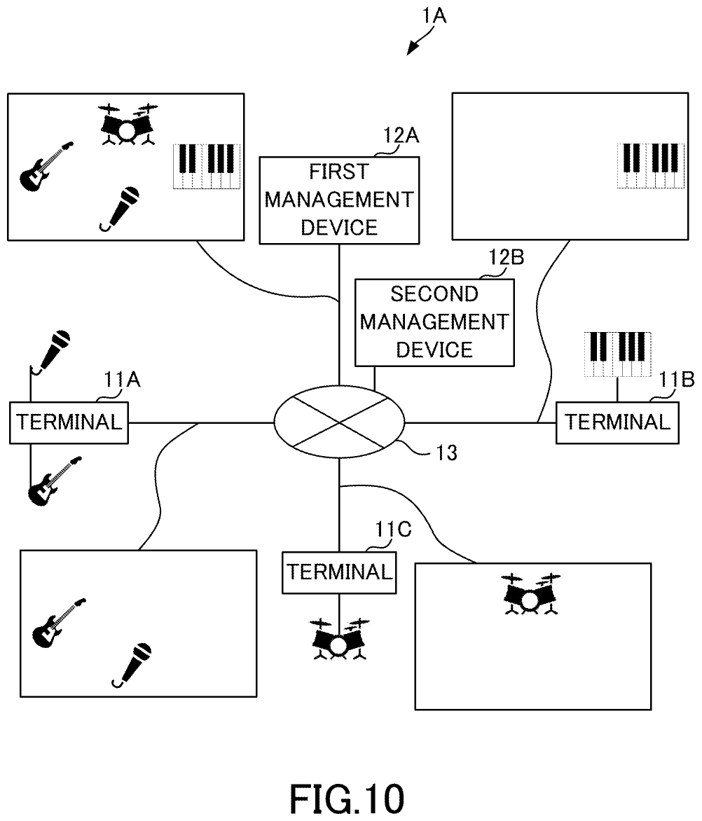

FIG. 10 is a block diagram showing a concept of a localization position of a sound of each terminal in an audio signal processing system 1A in a fifth modification. The audio signal processing system 1A according to the fifth modification performs a remote ensemble (a remote session) with the users of the terminal 11A, the terminal 11B, and the terminal 11C. The terminal 11A, the terminal 11B, and the terminal 11C each obtain an audio signal of a musical instrument, through a microphone or through a signal line such as an audio cable. The terminal 11A, the terminal 11B, and the terminal 11C each perform the localization processing based on the localization control information on the obtained audio signal. The terminal 11A, the terminal 11B, and the terminal 11C output the audio signal on which the localization processing has been performed, to a first management device 12A.

The localization control information is the same as the information in the various examples described above. However, the localization control information according to the fifth modification is preferably generated based on an attribute. The attribute in this example is a type of a sound (a musical instrument). For example, the localization position of a singing sound (vocals) is fixed in the front center, the localization position of a string instrument such as a guitar is fixed on the left side, the localization position of a percussion instrument such as a drum is fixed in the rear center, and the localization position of a keyboard instrument such as an electronic piano is fixed on the right side.

For example, the terminal 11A obtains an audio signal of vocals and a guitar. It is to be noted that the audio signal of vocals is obtained by a microphone and the audio signal of a guitar is obtained by a line (an audio cable). The terminal 11A performs the binaural processing to convolve such an HRTF as to be localized in the front center of the user, on the audio signal of vocals. The terminal 11A performs the binaural processing to convolve the HRTF to be localized on the left side of the user, on the audio signal of a guitar.

The terminal 11B obtains the audio signal of an electronic piano. The audio signal of an electronic piano is obtained by a line (an audio cable). The terminal 11B performs the binaural processing to convolve the HRTF to be localized on the right side of the user, on the audio signal of an electronic piano.

The terminal 11C obtains the audio signal of a drum. The audio signal of a drum is obtained by a microphone. The terminal 11C performs the binaural processing to convolve such an HRTF as to be localized in the rear center of the user, on the audio signal of a drum.

As a matter of course, in the fifth modification as well, the localization processing is not limited to the binaural processing and may be panning processing. In such a case, the localization control information shows left and right localization positions (a volume balance between the left and the right).

The terminal 11A, the terminal 11B, and the terminal 11C output the audio signal on which the localization processing has been performed as described above, to the first management device 12A. The first management device 12A has the same configuration and function as the above management device 12. The first management device 12A mixes the audio signals received from the terminal 11A, the terminal 11B, and the terminal 11C. In addition, the first management device 12A may receive the video signals from the terminal 11A, the terminal 11B, and the terminal 11C and combine the video signals into one video signal. The first management device 12A distributes the mixed audio signal and the combined video signal to a listener.

As a result, the listener who views and listens to the remote session can perceives the sound of each musical instrument as if arriving from a different position. In the fifth modification as well, the first management device 12A may distribute the audio signal of two channels (a stereo channel). Therefore, the configuration and operation of the audio signal processing system 1A according to the fifth modification are able to be implemented in any platform that distributes the audio signal of two channels (a stereo channel).

In addition, the terminal 11A, the terminal 11B, and the terminal 11C output the audio signal before the localization processing is performed, to a second management device 12B. The second management device 12B has the same configuration and function as the management device 12 and the first management device 12A. The second management device 12B receives and mixes the audio signal on which the localization processing is not performed at the terminal 11A, the terminal 11B, and the terminal 11C. The second management device 12B distributes the mixed audio signal to the terminal 11A, the terminal 11B, and the terminal 11C.

As a result, users who perform a remote session, respectively, at the terminal 11A, the terminal 11B, and the terminal 11C, can listen to a sound on which the localization processing is not performed, and can more easily monitor the sound of each user. The second management device 12B may also distribute the audio signal of two channels (a stereo channel). As a result, in any platform that distributes the audio signal of two channels (a stereo channel), the listener who views and listens to the remote session can listen to the sound of each musical instrument as if arriving from a different position, and the users who perform the remote session, respectively, at the terminal 11A, the terminal 11B, and the terminal 11C, can listen to the sound easy to be monitored.

Each terminal of a sixth modification, similarly to the fourth modification, performs processing to add an indirect sound to an audio signal. However, each terminal generates a first audio signal to which the indirect sound is added, and a second audio signal to which the indirect sound is not added. The first audio signal is an audio signal on which the localization processing has been performed as described above, for example. The second audio signal is an audio signal on which the localization processing is not performed as described above, for example.

As a result, the listener who views and listens to the remote session can listen to a sound with presence at a concert hall or the like, and the users who perform the remote session, respectively, at the terminal 11A, the terminal 11B, and the terminal 11C can listen to the sound easy to be monitored.

It is to be noted that the indirect sound preferably imitates the same acoustic space in all the terminals. As a result, the users (performers of the remote session) of the terminal 11A, the terminal 11B, and the terminal 11C who are in remote places can perceive as if doing a live performance in the same acoustic space.

For example, in the example of FIG. 10, each terminal may output the audio signal to which the indirect sound of a large concert hall is added, to the first management device 12A, and may output the audio signal to which the indirect sound of a small live venue is added, to the second management device 12B. In such a case, the first management device 12A distributes the audio signal to which the indirect sound of the large concert hall is added, and the second management device 12B distributes the audio signal to which the indirect sound of the small live venue is added. The listener may receive the audio signal that the first management device 12A distributes, and listen to the remote session that reproduces the reverberation of the large concert hall, or may receive the audio signal that the second management device 12B distributes, and listen to the remote session that reproduces the reverberation of the small live venue.

The terminal 11A, the terminal 11B, and the terminal 11C may further execute processing to add an ambient sound, on each audio signal. The ambient sound includes an environmental sound such as background noise, or a cheer, applause, calling, a shout, a chorus, or a murmur of the listener. As a result, the listener who views and listens to the remote session can also listen to the sound of an audience or the like, in a live venue, and can listen to a sound with more presence.

It is to be noted that each terminal preferably adds the ambient sound to the above first audio signal and does not add the ambient sound to the above second audio signal. As a result, the listener who views and listens to the remote session can listen to a sound with presence, and the users who perform the remote session, respectively, at the terminal 11A, the terminal 11B, and the terminal 11C, can listen to the sound easy to be monitored.

It is to be noted that the ambient sound is generated at random in an actual live venue. Then, the terminal 11A, the terminal 11B, and the terminal 11C may add respective different ambient sounds. As a result, since the ambient sound is generated at random, the listener can listen to a sound with more presence.

In addition, the ambient sound such as cheering, a shout, or a murmur, for example, may be different for each performer who performs a remote session. For example, the terminal that outputs the audio signal of vocals adds cheering, a shout, or a murmur of which the occurrence frequency and level are high. The terminal that outputs the audio signal of a drum adds cheering, a shout, or a murmur of which the occurrence frequency and level are low. Generally, the frequency and level of cheering, a shout, or a murmur to vocals being the leading role in a live performance are high while the frequency and level of cheering, a shout, or a murmur to the performance of other musical instruments (a drum, for example) are low. Therefore, the terminal that outputs an audio signal equivalent to the leading role of a live performance is able to reproduce more advanced presence by adding cheering, a shout, or a murmur of which the occurrence frequency and level are high.

The description of the present embodiment is illustrative in all points and should not be construed to limit the present disclosure. The scope of the present disclosure is defined not by the foregoing embodiments but by the following claims. Further, the scope of the present disclosure is intended to include all modifications within the scopes of the claims and within the meanings and scopes of equivalents.

What is claimed is:

1. An audio signal processing method used in an audio signal processing system including a plurality of terminals that output an audio signal, the method comprises:
obtaining localization control information that determines an acoustic image localization position of an own terminal in the audio signal processing system;
performing localization processing on the audio signal of the own terminal, based on the obtained localization control information; and
outputting the audio signal on which the localization processing has been performed.

2. The audio signal processing method according to claim 1, wherein:
the localization control information includes information that determines left and right localization positions; and
the localization processing includes panning processing.

3. The audio signal processing method according to claim 1, wherein:
the localization control information includes information that determines a three-dimensional localization position; and
the localization processing includes binaural processing.

4. The audio signal processing method according to claim 1, wherein the localization control information is generated based on unique identification information of each terminal.

5. The audio signal processing method according to claim 4, wherein:
the plurality of terminals output a video signal; and
the identification information is included in the video signal.

6. The audio signal processing method according to claim 1, wherein the localization control information is generated based on an attribute of a user of each terminal.

7. The audio signal processing method according to claim 1, further comprising:
obtaining space information that shows an acoustic space; and
processing to add an indirect sound corresponding to the acoustic space shown by the space information, on the audio signal of the terminal.

8. The audio signal processing method according to claim 7, further comprising:
generating a first audio signal to which the indirect sound is added, and a second audio signal to which the indirect sound is not added; and
outputting each of the first audio signal and the second audio signal.

9. The audio signal processing method according to claim 1, further comprising: processing to add an ambient sound, on the audio signal of the terminal.

10. The audio signal processing method according to claim 9, wherein the ambient sound is different for each of the plurality of terminals.

11. An apparatus comprising:
a terminal having a controller that is configured to:
obtain, in an audio signal processing system configured by a plurality of terminals including an own terminal, localization control information that determines an acoustic image localization position of the own terminal;
perform localization processing on the audio signal of the own terminal, based on the obtained localization control information; and
output the audio signal on which the localization processing has been performed.

12. The apparatus according to claim 11, wherein:
the localization control information includes information that determines left and right localization positions; and
the localization processing includes panning processing.

13. The apparatus according to claim 11, wherein:
the localization control information includes information that determines a three-dimensional localization position; and
the localization processing includes binaural processing.

14. The apparatus according to claim 11, wherein the localization control information is generated based on unique identification information of each terminal.

15. The apparatus according to claim 14, wherein:
the controller outputs a video signal; and
the identification information is included in the video signal.

16. The apparatus according to claim 11, wherein the localization control information is generated based on an attribute of a user of each terminal.

17. The apparatus according to claim 11, wherein the controller obtains space information that shows an acoustic space, and further comprising: processing to add an indirect sound corresponding to the acoustic space shown by the space information, on the audio signal of the terminal.

18. The apparatus according to claim 17, wherein the controller generates a first audio signal to which the indirect sound is added, and a second audio signal to which the indirect sound is not added, and outputs each of the first audio signal and the second audio signal.

19. The apparatus according to claim 11, further comprising: processing to add an ambient sound, on the audio signal of the terminal.

20. An audio signal processing system comprising:
a plurality of terminals;
a first management device; and
a second management device, wherein:
the plurality of terminals is configured to:
obtain localization control information that determines an acoustic image localization position of the audio signal processing system,
perform localization processing on the audio signal obtained by an own terminal, based on the obtained localization control information,
output the first audio signal on which the localization processing has been performed, to the first management device, and
output the second audio signal before the localization processing is performed, to the second management device;
the first management device mixes first audio signals outputted from each of the plurality of terminals; and
the second management device mixes second audio signals outputted from each of the plurality of terminals.
